(19) United States
(12) Patent Application Publication
(10) Pub. No.: US 2009/0310621 A1
(43) Pub. Date: Dec. 17, 2009

(54) Method to Classify the Network Speed

(75) Inventors: Ling Chang, Shanghai City (CN); Zhu-Min Di, Shanghai City (CN); Shih-Kuang Tsai, Shanghai City (CN)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: INVENTEC APPLIANCES CORP., Taipei Hsien (TW)

(21) Appl. No.: 12/478,963

(22) Filed: Jun. 5, 2009

(30) Foreign Application Priority Data
Jun. 12, 2008 (TW) 97121925

(51) Int. Cl. H04L 29/02; G06F 17/00; H04L 29/06; H04W 4/00; H04J 3/22

(52) U.S. Cl. 370/468; 726/1; 370/338

(57) ABSTRACT

A method to classify the network speed disclosed is utilized to distinguish between an advanced-level user bandwidth and a general-level user bandwidth for users whose devices are connected by the access point. The method includes selecting a bandwidth-distribution rule of the access point, and distributing the total bandwidth supported by the access point according to the selected bandwidth-distribution rule. The bandwidth-distribution rule is selected from a ratio-distribution rule, a highest-band restriction rule, and a lowest-bandwidth restriction rule. The bandwidth distributed to each advanced-level user is larger than the bandwidth distributed to each general-level user.

### RELATED APPLICATIONS

This application claims priority to Taiwan Application Serial Number 97121925, filed Jun. 12, 2008, which is herein incorporated by reference.

### BACKGROUND

1. Field of Invention

The present invention relates to a network service method. More particularly, the present invention relates to a method to classify the network speed.

2. Description of Related Art

With WLAN installations becoming progressively cheaper, WLAN is becoming more popular among consumers. With respect to hardware, desktop computers, notebook computers, hand-held mobile computing devices, such as palm computers and tablet PCs, all support wireless network connectivity. Many public locations including airports, cafes, and restaurants, etc. also have established hot spots for supplying wireless network service.

Generally, a WLAN includes several WLAN cards and an access point. The main function of the access point is to connect a wired network and a wireless network, wherein any personal computer with a wireless network card installed can share the resource in the wired network via the access point. The access point itself can also have network management functions, thereby performing necessary control on the personal computers.

The users who use the same access point would share the total bandwidth supported by the access point. However, it is difficult for the conventional access point to provide different bandwidths between the advanced-level user and the general-level user. Two WLANs and two access points are required to distinguish the advanced-level user bandwidth and the general-level user bandwidth in conventional WLAN system, and that is not easily controlled.

### SUMMARY

A purpose of the present invention is to provide a method to classify the network speed supported by an access point for distinguishing between an advanced-level user bandwidth and a general-level user bandwidth for users whose devices are connected by the access point, such that the bandwidth distributed to an advanced-level user is larger than that distributed to a general-level user.

The invention provides a method to classify the network speed supported by an access point to distinguish between an advanced-level user bandwidth and a general-level user bandwidth for users whose devices are connected by the access point. The method includes selecting a bandwidth-distribution rule of the access point, and distributing a total bandwidth of the access point to the users according to the selected bandwidth-distribution rule. The bandwidth-distribution rule is selected from a ratio-distribution rule, a highest-bandwidth restriction rule, and a lowest-bandwidth restriction rule. The bandwidth distributed to each advanced-level user is larger than the bandwidth distributed to each general-level user.

The invention provides a method to classify the network speed, which includes setting an advanced-level bandwidth ratio and a general-level bandwidth ratio, segmenting a total bandwidth of the access point into a total advanced-level bandwidth and a total general-level bandwidth according to the advanced-level bandwidth ratio and the general-level bandwidth ratio, distributing the total advanced-level bandwidth to plural advanced-level users, and distributing the total general-level bandwidth to plural general-level users. The sum of the advanced-level bandwidth ratio and the general-level bandwidth ratio is one.

The invention provides a method to classify the network speed, which includes setting a lowest bandwidth, and distributing a total bandwidth of the access point to plural advanced-level users and plural general-level users according to the lowest-bandwidth restriction rule. Each of plural advanced-level users is provided with the lowest bandwidth respectively, and the general-level users share a remaining bandwidth supported by the access point.

The invention provides a method to classify the network speed, which includes setting a highest bandwidth, and distributing a total bandwidth of the access point to plural advanced-level users and plural general-level users according to the highest-bandwidth restriction rule. Each of the plural general-level users is provided with the highest bandwidth respectively, and the advanced-level users share a remaining bandwidth supported by the access point.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a flow chart of a first embodiment of the method to classify the network speed of the invention;

FIG. 2 illustrates a flow chart of a second embodiment of the method to classify the network speed of the invention;

FIG. 3 illustrates a schematic diagram of an embodiment of an operation interface of the method to classify the network speed of the invention;

FIG. 4 illustrates a flow chart of a third embodiment of the method to classify the network speed of the invention;

FIG. 5 illustrates a flow chart of a fourth embodiment of the method to classify the network speed of the invention; and

FIG. 6 illustrates a flow chart of a fifth embodiment of the method to classify the network speed of the invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Many public locations such as airports, cafes and restaurants, have established hot spots for supplying wireless network service. The access point provides a plural advanced-level users and plural general-level users a network service. The advanced-level users and the general-level users may share the total bandwidth supported by the access point equally. However, an advanced-level user bandwidth cannot be distinguished from a general-level user bandwidth, and that is unfair to the advanced-level users who paid the fee. Therefore, the invention provides a method to classify the network speed supported by an access point to distinguish between an advanced-level user bandwidth and a general-level user bandwidth to ensure that the advanced-level user bandwidth is always larger than the general-level user bandwidth.

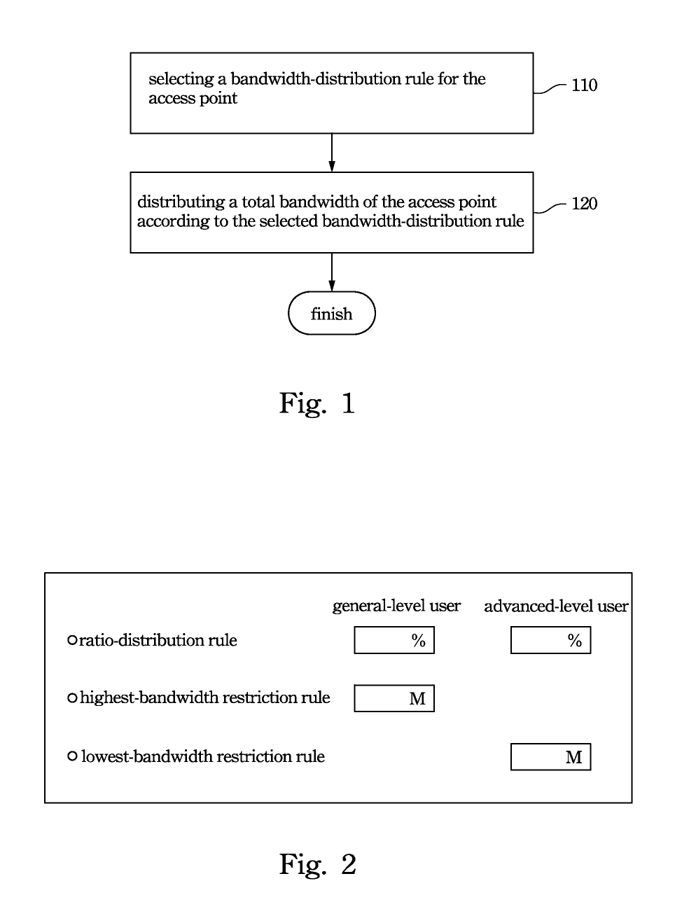

Refer to FIG. 1. FIG. 1 illustrates a flow chart of a first embodiment of the method to classify the network speed of the invention. The method to classify the network speed distinguishes between the advanced-level user bandwidth and the general-level user bandwidth. Step 110 of this embodiment is selecting a bandwidth-distribution rule for the access point. The bandwidth-distribution rule can be selected from a ratio-distribution rule, a highest-bandwidth restriction rule, and a lowest-bandwidth restriction rule. Then, in Step 120 is distributing a total bandwidth of the access point according to the selected bandwidth-distribution rule to ensure that the advanced-level user bandwidth is always larger than the general-level user bandwidth.

Refer to FIG. 2. FIG. 2 illustrates a schematic diagram of an embodiment of an operation interface of the method to classify the network speed of the invention. The selecting and the setting of the bandwidth-distribution rule can be integrated in the operation interface of the access point. The operation interface of the access point may include three modes consisting of the ratio-distribution rule, the highest bandwidth restriction rule, and the lowest bandwidth restriction rule. In other embodiments, there is only one bandwidth-distribution rule set at the access point.

The access point may further include a user management module to manage and store the advanced-level user's data and the general-level user's data, thus the advanced-level users can be distinguished from the general-level users when the users login to the access point. For example, the advanced-level user needs to type an advanced-level user ID and a code thereof when the advanced-level user logins the access point. The general-level user can type a public ID or a general-level user's ID and the code thereof when the general-level user logins to the access point.

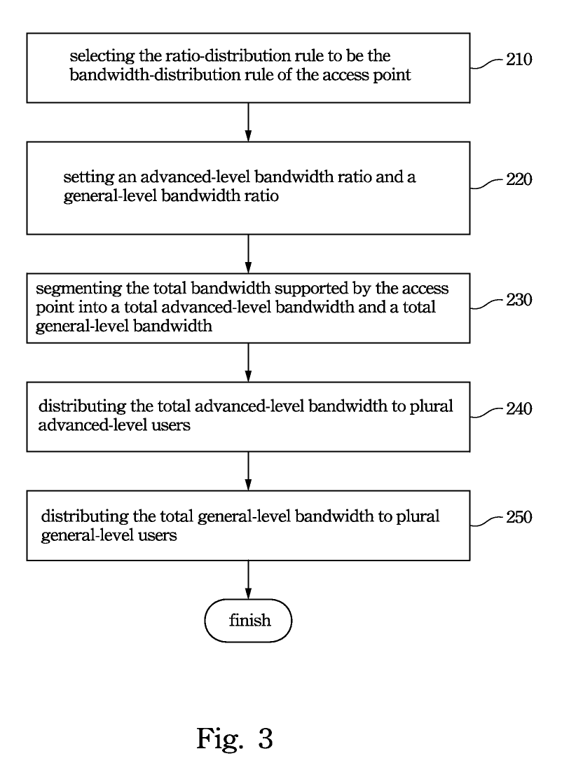

Refer to FIG. 3. FIG. 3 illustrates a flow chart of a second embodiment of the method to classify the network speed of the invention. Step 210 is selecting the ratio-distribution rule to be the bandwidth-distribution rule of the access point. Then, an advanced-level bandwidth ratio and a general-level bandwidth ratio are set in step 220. The sum of the advanced-level bandwidth ratio and the general-level bandwidth ratio is one. The advanced-level bandwidth ratio can be larger than the general-level ratio.

In Step 230, the total bandwidth supported by the access point is distributed to the users according to the ratio-distribution rule, wherein the total bandwidth of the access point is segmented into a total advanced-level bandwidth and a total general-level bandwidth according to the advanced-level bandwidth ratio and the general-level bandwidth ratio. Then in step 240, the total advanced-level bandwidth is distributed to plural advanced-level users, wherein the advanced-level users may share the total advanced-level bandwidth equally. In step 250, the total general-level bandwidth is distributed to plural general-level users, wherein the general-level users may share the total general-level bandwidth equally.

The number of the general-level users is normally more than the number of the advanced-level users. The total advanced-level bandwidth and the total general-level bandwidth can be properly controlled by setting the advanced-level bandwidth ratio and the general-level bandwidth ratio of the ratio-distribution rule to distinguish between the advanced-level user bandwidth and the general-level user bandwidth to ensure the bandwidth quality of the advanced-level user.

The advanced-level bandwidth ratio may preferably be larger than the general-level bandwidth to better distinguish the advanced-level user bandwidth from the general-level user bandwidth. For example, if the total bandwidth supported by the access point is 10 MHz, the total advanced-level bandwidth supported by the access point can be 9 MHz, and the total general-level bandwidth supported by the access point can be 1 MHz. Thus the advanced-level users can share 9 MHz of bandwidth, and the general-level users can share 1 MHz of bandwidth. The advanced-level user bandwidth can be highly improved.

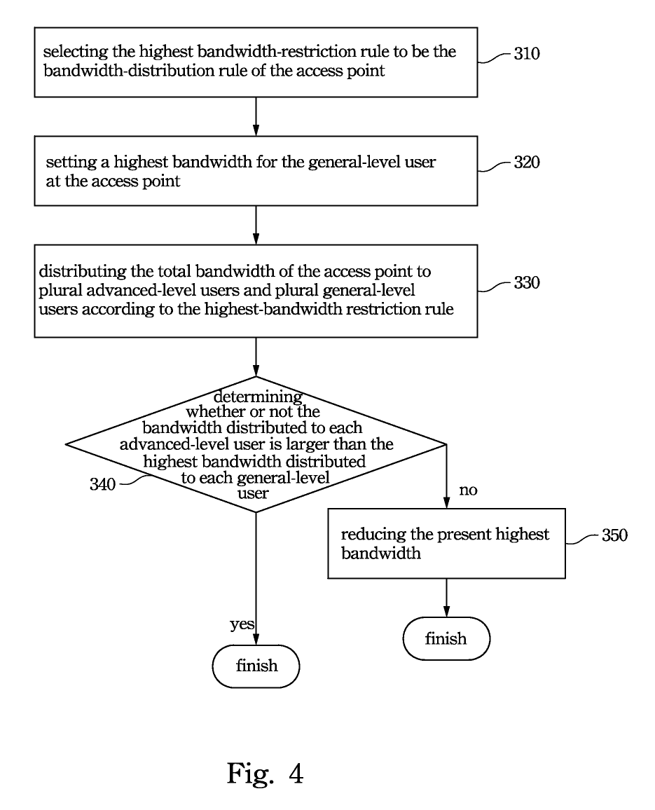

Refer to FIG. 4. FIG. 4 illustrates a flow chart of a third embodiment of the method to classify the network speed of the invention. In step 310, the highest-bandwidth restriction rule is selected to be the bandwidth-distribution rule of the access point. Then, step 320 is setting a highest bandwidth for the general-level user at the access point. In step 330 the total bandwidth of the access point is distributed to plural advanced-level users and plural general-level users according to the highest-bandwidth restriction rule. The step 330 is performed such that each general-level user is provided with the highest bandwidth respectively, and the advanced-level users share the remaining bandwidth supported by the access point.

The third embodiment may further include step 340 of determining whether or not the bandwidth distributed to each advanced-level user is larger than the highest bandwidth distributed to each general-level user. If the bandwidth distributed to each advanced-level user is smaller or is on the verge of becoming smaller than the highest bandwidth of each general-level user, then the preset highest bandwidth in step 350 is reduced to ensure that the advanced-level user bandwidth is larger than the general-level user bandwidth.

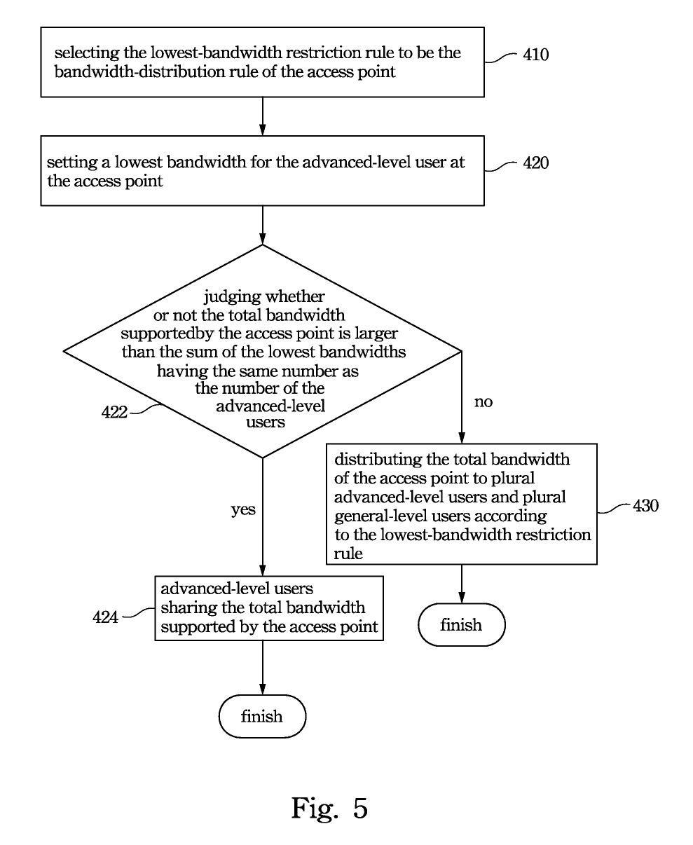

Refer to FIG. 5. FIG. 5 illustrates a flow chart of a fourth embodiment of the method to classify the network speed of the invention. In step 410 the lowest-bandwidth restriction rule is selected to be the bandwidth-distribution rule of the access point. Step 420 is setting a lowest bandwidth for the advanced-level user at the access point. Then, in step 430 the total bandwidth of the access point is distributed to plural advanced-level users and plural general-level users according to the lowest-bandwidth restriction rule. This step 430 is performed such that each advanced-level user is provided with the lowest bandwidth respectively, and the general-level users share the remaining bandwidth supported by the access point.

The fourth embodiment may further include a step 422 of judging whether or not the total bandwidth supported by the access point is larger than the sum of the lowest bandwidths having the same number as the number of the plural advanced-level users. If the total bandwidth supported by the access point is larger than the sum of the lowest bandwidths, this embodiment goes on to step 430 to distribute the total bandwidth supported by the access point according to the lowest-bandwidth restriction rule. If the total bandwidth supported by the access point is smaller than the sum of the lowest bandwidths of the advanced-level users, namely the number of the advanced-level users is more than expected thus the total bandwidth of the access point cannot be distributed according to the lowest-bandwidth restriction rule, this embodiment goes on to step 424, where the total bandwidth supported by the access point is all distributed to the advanced-level users, and the advanced-level users share the total bandwidth supported by the access point to ensure the internet speed of the advanced-level users.

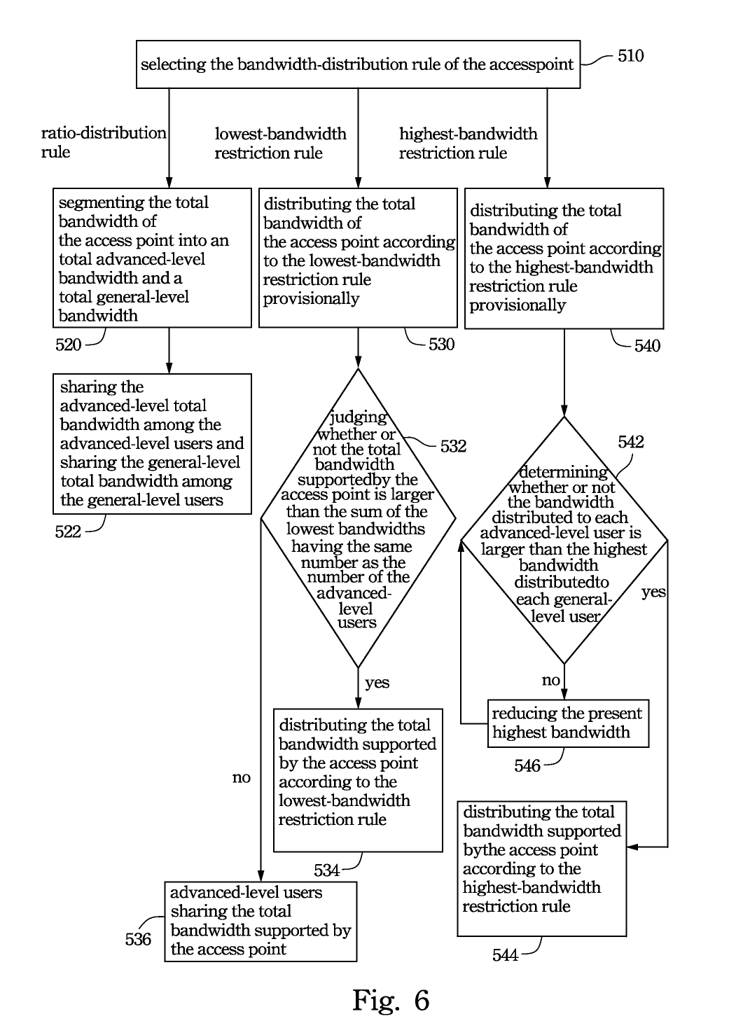

Refer to FIG. 6. FIG. 6 illustrates a flow chart of a fifth embodiment of the method to classify the network speed of the invention. Step 510 is selecting the bandwidth-distribution rule of the access point. The bandwidth-distribution rule is selected from the ratio-distribution rule, the highest-bandwidth restriction rule, and the lowest-bandwidth restriction rule. If the ratio-distribution rule is selected to be the bandwidth-distribution rule of the access point, the system goes to step 520, where the total bandwidth of the access point is segmented into the total advanced-level bandwidth and the total general-level bandwidth. Then, in step 522, the total advanced-level bandwidth is shared among the advanced-level users and the total general-level bandwidth is shared among the general-level users.

If the lowest-bandwidth restriction rule is selected to be the bandwidth-distribution rule in step 510, the embodiment goes to step 530, which distributes the total bandwidth supported by the access point according to the lowest-bandwidth restriction rule provisionally, wherein each advanced-level user is provided with the lowest bandwidth, and the general-level users share the remaining bandwidth supported by the access point. Then, step 532 is judging whether or not the total bandwidth supported by the access point is larger than the sum of the lowest bandwidths of the advanced-level users, wherein the lowest bandwidths have the same number as the number of the plural advanced-level users. If the total bandwidth of the access point is larger than the sum of the lowest bandwidths, this embodiment goes on to step 534 to distribute the total bandwidth supported by the access point according to the lowest-bandwidth restriction rule. If the total bandwidth supported by the access point is smaller than the sum of the lowest bandwidths of the advanced-level users, this embodiment goes on to step 536, which distributes all the total bandwidth supported by the access point to the advanced-level users, and the advanced-level users share the total bandwidth supported by the access point to improve the internet speed of the advanced-level users.

If the highest-bandwidth restriction rule is selected to be the bandwidth-distribution rule in step 510, then goes to step 540, which is distributing the total bandwidth supported by the access point according to the highest-bandwidth restriction rule provisionally. Step 542 determines whether or not the bandwidth distributed to each advanced-level user is larger than the highest bandwidth distributed to each general-level user. If the bandwidth distributed to each advanced-level user is larger than the highest bandwidth distributed to each general-level user, then step 544 distributes the total bandwidth supported by the access point according to the highest-bandwidth restriction rule. If the bandwidth distributed to each advanced-level user is smaller than the highest bandwidth distributed to each general-level user, then step 546 reduces the preset highest bandwidth, then the embodiment further returns to step 542 to ensure that the bandwidth distributed to each advanced-level user be larger than the bandwidth distributed to each general-level user.

However, the login number of the advanced-level users and the general-level users varies with time. Thus the access point may re-distribute the total bandwidth according to the bandwidth-distribution rule selected in step 510 when there is a user login or logout. The method to classify the network speed can ensure that the bandwidth distributed to each advanced-level user is larger than the bandwidth distributed to each general-level user as shown in step 532 and step 542.

According to the embodiments in the present invention, the method to classify the network speed provides the bandwidth-distribution rule to improve the Internet speed quality of the advanced-level users. The bandwidth-distribution rule can be selected from the ratio-distribution rule, the highest-bandwidth restriction rule, and the lowest-bandwidth restriction rule. The total bandwidth supported by the access point is distributed according to the bandwidth-distribution rule selected to ensure that the bandwidth distributed to each advanced-level user is always larger than the bandwidth distributed to each general-level user.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method to classify the network speed supported by an access point for distinguishing between an advanced-level user bandwidth and a general-level user bandwidth for users whose devices are connected by the access point, the method comprising:
setting an advanced-level bandwidth ratio and a general-level bandwidth ratio, wherein the sum of the advanced-level bandwidth ratio and the general-level bandwidth ratio is one;
segmenting a total bandwidth of the access point into a total advanced-level bandwidth and a total general-level bandwidth according to the advanced-level bandwidth ratio and the general-level bandwidth ratio;
distributing the total advanced-level bandwidth to a plurality of advanced-level users; and
distributing the total general-level bandwidth to a plurality of general-level users.

2. The method to classify the network speed of claim 1, wherein the advanced-level bandwidth ratio is larger than the general-level bandwidth ratio.

3. A method to classify the network speed supported by an access point for distinguishing between an advanced-level user bandwidth and a general-level user bandwidth for users whose devices are connected by the access point, the method comprising:
setting a lowest bandwidth; and
distributing a total bandwidth of the access point to a plurality of advanced-level users and a plurality of general-level users, such that each of the plurality of advanced-level users is provided with the lowest bandwidth respectively, and the general-level users share a remaining bandwidth supported by the access point.

4. The method to classify the network speed of claim 3, wherein the advanced-level users share the total bandwidth when the total bandwidth is smaller than the sum of the lowest bandwidths having the same number as the number of the plurality of advanced-level users.

5. A method to classify the network speed supported by an access point for distinguishing between an advanced-level user bandwidth and a general-level user bandwidth at an access point, the method comprising:
setting a highest bandwidth; and
distributing a total bandwidth of the access point to a plurality of advanced-level users and a plurality of general-level users, such that each of the plurality of general-level users is provided with the highest bandwidth respectively, and the advanced-level users share a remaining bandwidth supported by the access point.

6. The method to classify the network speed of claim 5, further comprising comparing the highest bandwidth and a bandwidth distributed to each of the plurality of advanced-level users, and, when the bandwidth distributed to each advanced-level user is on the verge of becoming smaller than the highest bandwidth, reducing the highest bandwidth.

7. A method to classify the network speed supported by an access point for distinguishing between an advanced-level user bandwidth and a general-level user bandwidth for users whose devices are connected by the access point, the method comprising:
selecting a bandwidth-distribution rule of the access point, wherein the bandwidth-distribution rule is selected from a ratio-distribution rule, a highest-bandwidth restriction rule, and a lowest-bandwidth restriction rule; and
distributing a total bandwidth of the access point to the users according to the selected bandwidth-distribution rule, wherein the bandwidth distributed to each advanced-level user is larger than the bandwidth distributed to each general-level user.

8. The method to classify the network speed of claim 7, wherein the selected bandwidth-distribution rule is the ratio-distribution rule.

9. The method to classify the network speed of claim 8, the ratio-distribution rule comprising:
setting an advanced-level bandwidth ratio and a general-level bandwidth ratio, wherein the sum of the advanced-level bandwidth ratio and the general-level bandwidth ratio is one;
segmenting the total bandwidth of the access point into a total advanced-level bandwidth and a total general-level bandwidth according to the advanced-level bandwidth ratio and the general-level bandwidth ratio;
distributing the total advanced-level bandwidth to a plurality of advanced-level users; and
distributing the total general-level bandwidth to a plurality of general-level users.

10. The method to classify the network speed of claim 9, wherein the advanced-level bandwidth ratio is larger than the general-level bandwidth ratio.

11. The method to classify the network speed of claim 7, wherein the selected bandwidth-distribution rule is the lowest-bandwidth restriction rule.

12. The method to classify the network speed of claim 11, the lowest-bandwidth restriction rule comprising:
setting a lowest bandwidth; and
distributing the total bandwidth of the access point to a plurality of advanced-level users and a plurality of general-level users, such that each of the plurality of advanced-level users is provided with the lowest bandwidth respectively, and the general-level users share a remaining bandwidth supported by the access point.

13. The method to classify the network speed of claim 12, wherein the advanced-level users share the total bandwidth when the total bandwidth is smaller than the sum of the lowest bandwidths having the same number as the number of the plurality of advanced-level users.

14. The method to classify the network speed of claim 7, wherein the selected bandwidth-distribution rule is the highest-bandwidth restriction rule.

15. The method to classify the network speed of claim 14, the highest-bandwidth restriction rule comprising:
setting a highest bandwidth; and
distributing the total bandwidth of the access point to a plurality of advanced-level users and a plurality of general-level users, such that each of the plurality of general-level users is provided with the highest bandwidth respectively, and the advanced-level users share a remaining bandwidth supported by the access point.

16. The method to classify the network speed of claim 15, further comprising comparing the highest bandwidth and a bandwidth distributed to each of the plurality of advanced-level users, and, when the bandwidth distributed to each advanced-level user is on the verge of becoming smaller than the highest bandwidth, reducing the highest bandwidth.
